(19) United States
(12) Patent Application Publication
(10) Pub. No.: US 2024/0283260 A1
(43) Pub. Date: Aug. 22, 2024

(54) REMOTE CONTROLLER WITH CAPACITOR MODULE FOR CHARGING AND CHARGING METHOD THEREOF

(71) Applicant: Planet Love Co., LTD., Gimhae-si (KR)

(72) Inventors: Eui Suk KANG, Changwon-si (KR); Jung Hyun CHOI, Goseong-gun (KR)

(21) Appl. No.: 18/111,912

(22) Filed: Feb. 21, 2023

(51) Int. Cl. H02J 7/00; H02J 7/34; H02J 7/35; H02M 3/158

(52) U.S. Cl. CPC H02J 7/0029; H02J 7/345; H02J 7/35; H02M 3/1582

(57) ABSTRACT

A present invention relates to a remote controller using a hybrid capacitor charging method, which includes: a body; a solar cell coupled to the body; a USB C port to receive external power and charge the capacitor module; a booster configured to boost a voltage received from the solar cell higher than a fully charged voltage of the capacitor module; a voltage converter configured to convert the voltage of an external power supplied from the USB C port; a capacitor protector configured to output a balanced DC voltage when a DC voltage is input to the capacitor module by receiving one or more voltages from the booster and the voltage converter; the capacitor module configured to charge capacitor cells; and a power controller configured to control a discharge of the capacitor module by converting the charged DC voltage into a DC voltage for operating the controller.

### FIELD OF THE INVENTION

The present invention relates to a remote control, and more particularly, relates to a remote controller of a hybrid capacitor charging method having a cell balance function to prevent overcharging, transient current, and transient voltage through a capacitor protector during charging, and to enable charging with a DC voltage balanced with the stabilization of a cell of a capacitor module.

### BACKGROUND OF THE INVENTION

In general, electronic devices such as TVs, PCs, fans, air conditioners, audio, machine tools, etc. used in places such as homes, offices, factories, etc. are equipped with remote controls for the convenience of the user, so that remote control by the user is possible.

The remote control by the remote control may receive a remote control signal transmitted from the transmitter according to the input unit operation of the remote control through the remote control receiver provided in the electronic device and transmits it to the control unit, the control unit may determine the remote control signal transmitted through the remote control receiver and perform a control operation based upon the control signal, thereby controlling the electronic device.

Such a remote control is typically used by inserting a battery corresponding to a primary battery as an operating power source for the input and transmission units.

However, the above remote control has inconvenient purchase costs and replacement due to battery consumption, and there is a problem that a power supply unit accommodating the battery must be provided separately, and when the battery is used for a long time, corrosion occurs in the power supply part of the remote control. In addition, when an impact occurs, there is a problem in that the cap formed in the power supply unit is damaged.

On the other hand, as shown in FIG. 1, in a Korean Patent Publication No. 10-2007-0099262 (2007 Oct. 9), a rechargeable remote control, which includes an input terminal 10 formed on the lower side of the case 3 and configured to receive a current from a power charging jack 8 of an electronic device 9 through a cable 7, a current controller 20 configured to control a current supplied through the input terminal 10; a lithium-ion polymer 31 in which a controlled current is charged through the current controller 20, a lithium-ion polymer battery 30 in which the outside of the lithium-ion polymer 31 is treated with a silver foil pouch 32, has been proposed.

However, the proposed technology uses a lithium-ion polymer corresponding to a secondary battery that can be reused by charging as an operating power source for a remote control, leading to solving only one time using problem of the primary battery, but limited to the number of charge and discharge.

Since it is a chemical battery using a chemical reaction like the primary battery, the problem of environmental pollution that occurs during the treatment process still remains due to waste treatment at the end of its life.

### SUMMARY OF THE INVENTION

### Problems to be Solved

The object of the present invention, which was made to solve the above problems, is to boost the electrical energy of the solar cell and convert the voltage of external power supplied through the USB C port so that are capacitor modules having a plurality of capacitor cells configured in serial and/or parallel can be rapidly charged, it is to prevent overcharge, overcurrent and overvoltage through a capacitor protector during charging, and to provide a hybrid capacitor charging method remote control having a cell balance function to enable charging with a balanced DC voltage and cell stabilization of the capacitor module.

### Means to Solve the Problem

According to an embodiment(s) of the present invention for achieving the above-described object, a remote control coupled with an input unit 20 and a transmitter 30 in the body 10 to transmit a control signal for remote control of an electronic device may include: a solar cell 100 configured to convert light energy of sunlight or lighting mounted on a printed circuit board (PCB) 40 and convert into electrical energy; a USB C port 200 coupled to a Printed Circuit Board (PCB) 40 and connected to a cable of the USB Power Delivery (PD) charger 210 to charge a capacitor module by receiving an external power; a booster 300 configured to boost the voltage of electrical energy converted in the solar cell 100 to a higher than a full charging voltage of the capacitor module so that rapid charging of the capacitor module is possible;
a voltage converter 400 configured to convert a voltage of an external power supply supplied from the USB PD charger 210 through the USB C port 200;
a capacitor protector 500 configure to input a DC voltage to the capacitor module 600 by receiving one or more voltages from the booster 300 and voltage converter 400 and perform cell balancing for capacitor module 600, thereby enabling stabling of cell for charging with a balanced DC voltage;
a capacitor module 600 configured to charge by receiving a cell balanced DC voltage output from the capacitor protector 500, and is modularized by in serial and/or parallel with a plurality of capacitor cells;
a power controller 700 configured to convert a DC voltage charged to the capacitor module 600 so that it can be used for a power supply for operation of the input unit 20 and the transmitter 30 to control a discharge of the capacitor module 600.
a power controller 700 configured to convert the DC voltage charged to the capacitor module 600 for operating the input unit 20 and the transmitter 30, and to control discharging the capacitor module 600; and
a display 800 configured to display a status of charging the capacitor module 600.

In addition, the booster 300 may include a DC-DC boost converter 310 to boost the voltage of the electrical energy converted in the solar cell 100 higher than the full charge voltage of the capacitor module 600.

In addition, the voltage converter 400 may include a data detector 410 for receiving voltage data of an external power supply supplied from the USB PD charger 210.

In addition, the capacitor protector 500 may further include a comparator 510 configured to receive a voltage V_{IN+} and a reference voltage V_{IN-} from the booster 300 and the voltage converter 400 at a plurality of input terminals, respectively, and compare and output an output voltage V_{OUT} using an operational amplifier if a voltage difference between the voltage V_{IN+} and the reference volage V_{IN-} when comparing the voltages.

In addition, the comparison circuit 510 may include a transistor TR 520 that plays a switching role so that charging is determined according to the voltage of the cell while charging the capacitor module 600 is charged through the output voltage V_{OUT}, and a zener diode 530 that supplies a constant voltage to each cell of the capacitor module 600.

In addition, the capacitor cell of the capacitor module 600 may use one or more of an electric double layer capacitor (EDLC) and a lithium-ion capacitor (LIC). However, it is not limited thereto.

In addition, the power controller 700 may include a DC-DC buck-boost converter 710 that boosts or steps down the DC voltage charged to the capacitor module 600.

In addition, the indicator 800 may receive an output voltage V_{OUT} from the comparison circuit 510 of the capacitor protector 500 and display a charging state of the capacitor module 600. A plurality of LED lamps 810 may be displayed flashing red or green, or displayed as characters on a screen.

In addition, the indicator 800 may indicate a state of charge of the capacitor module 600 when that external power is being supplied through the solar cell 100 or the USB C port 200, or when a user manipulates the input unit 20.

### EFFECTS OF THE INVENTION

The remote control of the hybrid capacitor charging method according to the present invention may have the following effects:

First, the booster may boost the converted electric energy of the solar cell to a value 2 to 3 times a full charge voltage of the capacitor module. By boosting, the high input voltage fundamentally prevents the internal resistance, Equivalent Series Resistance (ESR) from interfering with the flow of current as a charging voltage of the capacitor module increases due to the low input voltage, thereby the capacitor module can be rapidly being charged.

Second, by supporting USB PD capable of supplying up to 100 W of power through the USB C port connected to the cable of the USB Power Delivery (PD) charger, it has the effect of enabling fast charging of the capacitor module.

Third, through the capacitor protector, one or more voltages V_{IN+} and reference voltages V_{IN-},respectively, are received from the booster and the voltage conversion unit, respectively, and the output voltage V_{OUT} is generated only when there is a voltage difference to prevent an overcharge, a transient current, and/or a transient voltage of the capacitor module.

The remote control of the hybrid capacitor according to the present invention may include a transistor to switch for charging according to a cell voltage and a Zener diode to provide a constant voltage to each cell of the capacitor module. Therefor, there is an effect of performing a cell balancing function so that cells of the capacitor module can be stabilized and charged with a balanced DC voltage.

Fourth, by receiving the output voltage V_{OUT} of the capacitor protector through the indicator, and displaying the charging status of the capacitor module by flashing red or green with a plurality of LED lamps, or displaying it as a character on the screen, the user can easily recognize the charging state of the capacitor module.

### BRIEF DESCRIPTION OF THE DRAWINGS

FIG. 1 is a block diagram of a rechargeable remote control according to the prior art.

FIG. 2 is a block diagram of an embodiment of a remote controller using a hybrid capacitor charging method according to the present invention.

FIG. 3 is a diagram illustrating a Printed Circuit Board (PCB) coupled to the inside of the remote control based on the embodiment of FIG. 2.

FIGS. 4A and B are diagrams showing the front side and back side of the outside of the remote control respectively based on the embodiment of FIG. 2.

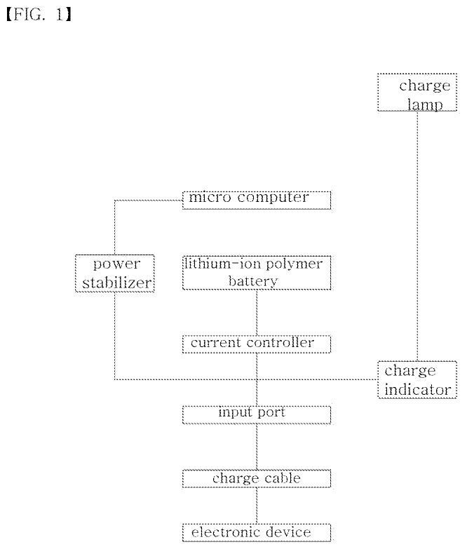

### DETAILED DESCRIPTION OF THE EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Terms used in the present specification are used for explaining a specific exemplary embodiment, not for limiting the present inventive concept. Thus, an expression used in a singular form in the present specification also includes the expression in its plural form unless clearly specified otherwise in context. As used herein, the term “and/or” includes any and all combinations of one or more of the associated listed items. Expressions such as “at least one of when preceding a list of elements, modify the entire list of elements and do not modify the individual elements of the list.

First, the remote control of the hybrid capacitor charging method according to the present invention, in generally the input unit 20 and the transmission unit 30 are coupled to the body 10 to enable remote control of electronic devices such as TVs, PCs, fans, air conditioners, audio, machine tools, etc. used in places such as homes, offices, factories, etc., as described above in the background art prior to describing the core components.

That is, when the user operates the input unit 20, the corresponding remote control signal is transmitted from the transmitter 30 to the electronic device, and the electronic device receives it and operates according to the remote control signal.

In addition, the remote control may communicate with the electronic device by wire or wireless, and may be further configured to include a receiver for collecting information of the electronic device according to the purpose of use, for example, to monitor an operation state of the electronic device.

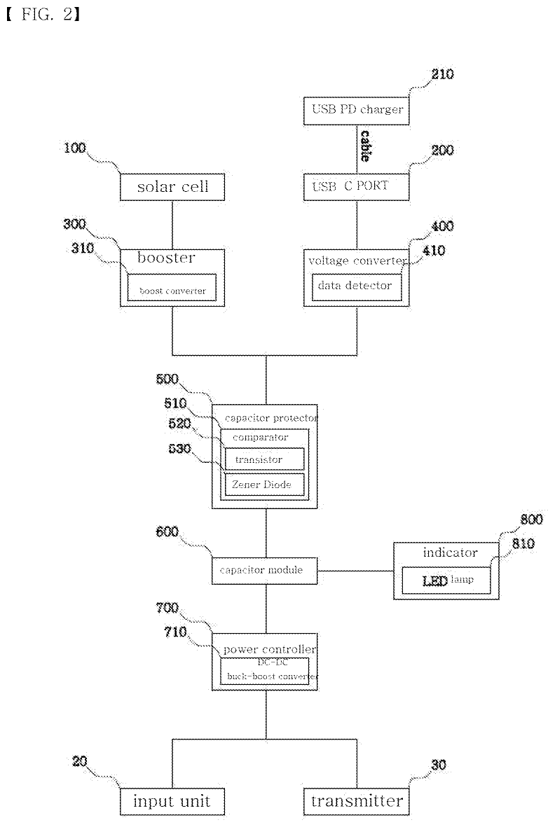

As shown in FIGS. 2 to 4, a remote control of a hybrid capacitor charging method according to aspects of the present invention may include a solar cell 100, a USB C port 200, a booster 300, a voltage converter 400, a capacitor protector 500, a capacitor module 600, a power controller 700, and an indicator 800 according to an embodiment of the present invention.

A solar cell 100 is coupled to a body 10 of the remote control as shown in FIGS. 2 to 4, and a means or a device for converting the light energy of sunlight or illumination mounted on the PCB (Printed Circuit Board, 40) into electrical energy, it is a device for charging a capacitor module 600 to be described later.

Here, the solar cell 100 may be mounted on the printed circuit board (PCB) 40 and coupled to expose the rear surface of the body 10 of the remote control.

This is configured to be easily coupled to the PCB through the mount, thereby improving ease of assembly and thickness miniaturization of the body 10 of the remote control.

In addition, the horizontal×vertical size of the solar cell 100 may be determined according to the size of the body 10 of the remote control, and a plurality of cells may be composed serial and/or in parallel.

The USB C type port 200 is coupled to the printed circuit board (PCB) 40 as shown in FIGS. 2 to 4, and connected to a cable of the USB Power Delivery (PD) charger 210 to receive an external power to charge the capacitor module 600 to be described later.

Here, the USB PD charger 210 connected to the USB C port 200 is a USB power expansion standard capable of supplying power up to 100 W using a USB cable, and the conventional USB 2.0 capable of supplying power up to 2.5 W, USB 3.0 capable of supplying power up to 4.5 W, respectively, and the charging standard USB Battery Charging (BC) 1.2 can supply power up to 7.5 W.

In addition, the USB PD charger 210 is capable of supplying power up to 100 W, thereby enabling power supply to tablet PCs and notebooks that could not be supported previously, and fast charging of mobile devices.

According to aspects of the present invention, it is configured for rapid charging of the capacitor module 600 to be described later.

That is, the USB C port 200 corresponds to the USB PD (Power Delivery) charger 210 capable of rapid charging, and the capacitor module 600 is rapidly charged and data is rapidly transmitted through a USB-C cable.

On the other hand, rapid charging is possible because the capacitor module 600, which has positive characteristics capable of rapid charging and negative characteristics capable of rapidly discharging, is composed of miniaturized capacitor cells in serial and/or parallels.

In addition, in order to use as a power source for the input unit 20 and the transmission unit 30 of the remote control, it is characterized by modularization by configuring miniaturized capacitor cells in series and parallel to compensate for the problem of the negative characteristic of rapid discharge.

In addition, the data transmission function of the USB C port 200 is connected to the data detector 410 of the voltage converter 400 to be described later, and voltage data of an external power supply supplied from the USB PD charger 210 may be received.

The booster 300 is a means of boosting the voltage of electrical energy converted in the solar cell 100 to higher than a full charging voltage of the capacitor module and is couple to the above print circuit board 40, as shown in FIG. 2.

In addition, the data transmission function of the USB C port 200 is connected to the data detector 410 of the voltage converter 400 to be described later, and voltage data of an external power supply supplied from the USB PD charger 210 may be received.

In other words, the booster 300 may boost the converted electric energy of the solar cell 100 to a value 2 to 3 times a full charge voltage of the capacitor module 600. By boosting, the high input voltage fundamentally prevents the internal resistance, Equivalent Series Resistance (ESR) from interfering with the flow of current as the charging voltage of the capacitor module increases due to the low input voltage, thereby the capacitor module can be rapidly being charged.

Accordingly, there is an effect of rapid charging of the capacitor module 600 by boosting the electrical energy converted from the light energy of indoor lighting including outdoor sunlight.

For this, the booster 300 may include a DC-DC boost converter 310, which boosts the voltage of the electrical energy converted in the solar cell 100 higher than the fully charged voltage of the capacitor module 600.

The voltage converter 400 is a means for converting a voltage of an external power supply supplied from the USB PD charger 210 through the USB C port 200 as shown in FIG. 2.

The voltage converter 400 may include a data detector 410, which is coupled to the printed circuit board (PCB) 40 and receive voltage data of an external power supply supplied from the USB PD charger 210.

For example, voltage data of an external power supply supplied from the USB PD charger 210 is received, a voltage of 5V or 8V, 12V, or 20V is applied, and then converted into a charging voltage of the capacitor module 600 to rapidly charge the capacitor module 600.

For this, the voltage converter 400 may be configured with a DC-DC buck-boost converter that boosts or steps down the applied voltage.

As shown in FIG. 2, the capacitor protector 500 may be connected to the PCB (Printed Circuit Board 40, configured to receive any one or more voltages from the booster 300 and the voltage converter 400, and perform a cell balance function to enable cell stabilization and charging capacitor module 600 with a balanced DC voltage when inputting a DC voltage to the capacitor module 600.

Specifically, the capacitor protector 500 may further include a comparator 510 configured to receive a voltage V_{IN+} and a reference voltage V_{IN-} from the booster 300 and the voltage converter 400 at a plurality of input terminals, respectively, and compare the voltage V_{IN+} and the reference voltage V_{IN-} and output an output voltage V_{OUT} using an operational amplifier if the voltages are different from each other, thereby preventing overcharging, a transient current, and/or a voltage transient voltage of the capacitor module.

In addition, the comparison circuit 510 may include a transistor TR 520 that plays a switching role so that charging is determined according to the voltage of the cell while charging the capacitor module 600 is charged through the output voltage V_{OUT}, and a Zener diode 530 that supplies a constant voltage to each cell of the capacitor module 600. Through this, the cell stabilization of the capacitor module and the cell balance function are performed so that charging the capacitor module 600 with a balanced DC voltage is possible.

As shown in FIGS. 2 and 3, the capacitor module 600 is charged by receiving a cell balance DC voltage output from the capacitor protector 500, and is modularized by configuring a plurality of capacitor cells (cells) made of a predetermined small size, for example a standard size.

Here, the capacitor module 600 may be modularized by configuring a large number of small-sized capacitor cells in series and parallel to enable rapid charging, thereby allowing a large number of charging currents to flow with a low internal resistance and a high potential difference to be used as an operating power supply for the input unit 20 and the transmitter 30 of the remote control.

This feature uses the static characteristic that allows rapid charging of the capacitor, and is also to compensate for the problem of negative characteristics in which rapid discharge is performed. And compared to secondary batteries, it has a very long charging and discharging frequency of more than 20,000 times and can be used for more than 10 years, which has the effect of reducing heavy metal environmental pollution.

For this, the capacitor cell of the capacitor module 600 may be used as one or more of an electric double layer capacitor (EDLC) and a lithium-ion capacitor (LIC).

An electric double layer capacitor (EDLC) is a super capacitor, which is a type of capacitor that stores electrical energy by the Faraday effect caused by electron movement between the electrode and the electrolyte, and uses the Helmholtz double layer at the interface between the electrode and the electrolyte. It has an advantage of a long charging and discharge life while being able to charge rapidly.

The lithium-ion capacitor (LIC: LIC: Li-ion capacitor) has (−) electrode activated carbon or graphite with lithium inserted (or doped) as in lithium-ion storage batteries, the (+) pole activated carbon like the electric double-layer capacitor (EDLC), and the lithium salt dissolved in the electrolyte as in lithium-ion storage batteries.

In other words, by combining the advantages of lithium-ion storage batteries and electric double-layer capacitors (EDLC), it is also called a hybrid capacitor.

As a result, it has the advantage of maintaining the traditional characteristics of capacitors such as fast charging/discharging, high durability, safety, and environmental friendliness, while exerting the core characteristics of storage batteries such as a high voltage and a lot of energy.

As shown in FIG. 2, the power controller 700 converts the DC voltage charged in the capacitor module 600 into a DC voltage so that it can be used as power for the operation of the input unit 20 and the transmission unit 30. As a means for controlling the discharge of the capacitor module 600, it is coupled to the Printed Circuit Board (PCB) 40.

For this, the power controller 700 includes a DC-DC buck-boost converter 710 that boosts or steps down the DC voltage charged to the capacitor module 600.

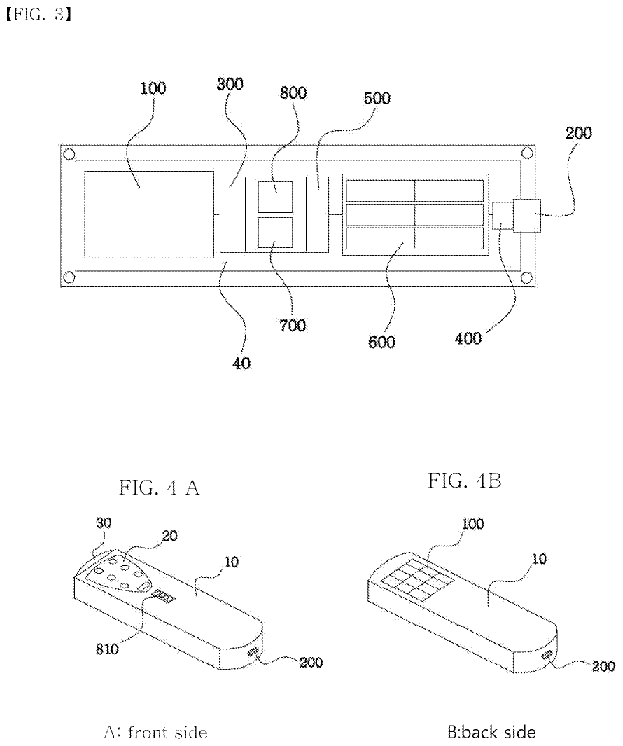

The indicator 800 is coupled to be exposed to the body 10 as shown in FIGS. 2 and 4, and is a means for displaying to a user a charging state of the capacitor module 600,

An output voltage V_{OUT} is received from the comparator 510 of the capacitor protector 500 to indicate a charging state of the capacitor module 600, but a plurality of LED lamps 810 are displayed flashing red or green, or may be displayed as characters on the screen.

In addition, the indicator 800 is configured to display the charging state of the capacitor module 600 when an external power is supplied through the solar cell 100 or the USB C type port 200, or when the user operates the input unit 20. By preventing unnecessary display except during charging or use, the user can easily check the charging state of the capacitor module 600 while lowering power consumption.

Therefore, the remote control of the hybrid charging method using a capacitor and a solar cell according to aspect(s) of the present invention may have at least the following effects.

First, by boosting the converted electrical energy of the solar cell through the booster to a value of 2˜3 times the full charge voltage of the capacitor module, an Equivalent Series Resistance (ESR) is increased as a charging voltage of a capacitor module is increased due to a low input voltage, thereby fundamentally preventing an interruption of a current flow, thereby enabling a rapid charging of the capacitor module.

Second, by using a USB PD capable of supplying up to 100 W of power through the USB C port connected to a cable of the USB PD charger, it has an effect of enabling fast charging of the capacitor module.

Third, by receiving through the voltage protector a voltage V_{IN+} and a reference voltage V_{IN-} from the booster 300 and the voltage converter 400, respectively, and comparing the voltage V_{IN+} and the reference voltage V_{IN-} and outputting an output voltage V_{OUT} using an operational amplifier if the voltages are different from each other, thereby preventing overcharging, a transient current, and/or a voltage transient voltage of the capacitor module.

In addition, a transistor that plays a role so that charging is determined according to a voltage of the cell of the capacitor module using the output voltage V_{OUT}, and a Zener diode that supplies a constant voltage to each cell of the capacitor module. Through this, the cell stabilization of the capacitor module and the cell balance function are performed so that charging the capacitor module 600 with a balanced DC voltage is possible.

Fourth, by receiving the output voltage V_{OUT} of the capacitor protector through the indicator, and displaying the charging status of the capacitor module by flashing red or green with a plurality of LED lamps, or displaying it as a character on the screen, the user can easily recognize a charging state of the capacitor module.

It will be apparent to those skilled in the art that various modifications and variations can be made in the present invention without departing from the spirit or essential characteristics thereof. Therefore, the embodiments disclosed in the present invention are intended to illustrate rather than limit the scope of the present invention, and the scope of the technical idea of the present invention is not limited by these embodiments. The scope of protection of the present invention should be construed according to the following claims, and all technical ideas within the scope of the same should be interpreted as being included in the scope of the present invention.

[Explanation of symbols]

| | |
|---|---|
| 10: body | 20: input unit |
| 30: Transmitter | 40: PCB |
| 100: solar cell | 200: USB C port |
| 300: booster | 310: DC-DC boost converter |
| 400: voltage convertor | 410: data detector |
| 500: capacitor protector | 510: comparator |
| 520: transistor | 530: Zener diode |
| 600: capacitor module | 700: power controller |
| 710: DC-DC buck-boost converter | 800: indicator |
| 810: LED lamp | |

What is claimed is:

1. A remote controller using a hybrid capacitor charging method of claim 1, comprising:
a body 10;
an input unit 20;
a transmitter 30;
wherein the input unit 20 and the transmitter 30 are coupled to the body 10 to transmit a control signal for remote control of electronic devices;
a solar cell 100 coupled to the body 10 of the remote controller and converting light energy of sunlight or lighting mounted on a printed circuit board 40 (PCB) into electrical energy;
a USB C port 200 coupled to the Printed Circuit Board (PCB) 40 and connected to a cable of a USB Power Delivery (PD) charger 210 to receive an external power and charge the capacitor module;
a booster 300 configured to boost a voltage of the electric energy converted in the solar cell 100 higher than a fully charged voltage of the capacitor module so that the capacitor module can be rapidly charged;
a voltage converter 400 configured to convert the voltage of external power supplied from the USB PD charger 210 through the USB C port 200;
a capacitor protector 500 configured to perform a cell balance function so that charging is possible with a balanced DC voltage when a DC voltage is input to the capacitor module 600 by receiving one or more voltages from the booster 300 and the voltage converter 400;
a capacitor module 600 configured to charge by receiving the cell balance DC voltage output from the capacitor protector 400 and modularized by configuring a plurality of small-sized capacitor cells in serial and parallel;
a power controller 700 configured to control a discharge of the capacitor module 600 by converting the DC voltage charged in the capacitor module 600 into a DC voltage for operating the input unit 20 and the transmission unit 30; and
an indicator 800 exposed to the body 10 and configured to display a charging state of the capacitor module 600 to a user.

2. The remote controller using a hybrid capacitor charging method of claim 1, wherein the booster 300 further comprises a DC-DC boost converter 310 to boost a voltage of the electrical energy converted in the solar cell 100 higher than a full charge voltage of the capacitor module 600.

3. The remote controller using a hybrid capacitor charging method of claim 1, wherein the voltage converter 400 comprises a data detector 410 is configured to receive a voltage data of an external power supply supplied from the USB PD charger 210.

4. The remote controller using a hybrid capacitor charging method of claim 1, wherein the capacitor protector 500 further includes an operational amplifier to output an output voltage V_{OUT} by receiving one or more voltages V_{IN+} and reference voltage V_{IN-} from the booster 300 and the voltage conversion unit 400 respectively at the plurality of input terminals charging remote output voltage V_{OUT} when the voltage V_{IN+} and the reference voltage V_{IN-} are different from each other.

5. The remote controller using a hybrid capacitor charging method of claim 1,
wherein the comparator 510 comprises a transistor 520 switches for charging with the output voltage V_{OUT} according to a voltage of the cell and a Zener diode 530 supplies a constant voltage to each cell of the capacitor module 600 while charging the each cell of the capacitor module 600.

6. The remote controller using a hybrid capacitor charging method of claim 1,
wherein the cell of the capacitor module 600 is one or more selected from an electric double layer capacitor (EDLC) and a lithium-ion capacitor (LIC: Li-ion capacitor).

7. The remote controller using a hybrid capacitor charging method of claim 1, wherein the power controller 700 further comprises a DC-DC buck-boost converter 710 for boosting or stepping down a DC voltage charged to the capacitor module 600.

8. The remote controller using a hybrid capacitor charging method of claim 1, wherein the indicator 800 is configured to receive an output voltage V_{OUT}from the comparison circuit 510 of the capacitor protector 500 and display a charging state of the capacitor module 600 with a plurality of LED lamps 810 flashing red or green, or display as a text on a screen.

9. The remote controller using a hybrid capacitor charging method of claim 1, wherein the indicator 800 is configured to display a charging state of the capacitor module 600 when an external power supply is supplied through the solar cell 100 or the USB C port 200, or when the user operates the input unit 20.
